(19) United States
(12) Patent Application Publication
(10) Pub. No.: US 2009/0309451 A1
(43) Pub. Date: Dec. 17, 2009

(54) ELECTRICAL MACHINE WITH SINGLE-TOOTH ROTOR WINDING

(76) Inventor: Gerald Roos, Sasbachried (DE)

Correspondence Address: MERCHANT & GOULD PC, P.O. BOX 2903, MINNEAPOLIS, MN, 55402-0903, US

(21) Appl. No.: 12/376,015

(22) PCT Filed: Jul. 31, 2007
(86) PCT No.: PCT/EP07/57881

§ 371 Date: Feb. 2, 2009

(30) Foreign Application Priority Data
Aug. 7, 2006 (DE) 10 2006 036 835.5

(51) Int. Cl. H02K 3/28

(52) U.S. Cl. 310/179

(57) ABSTRACT

The invention relates to an electrical machine with at least eight exciter poles in the stator and with a commutator rotor, comprising numerous pole teeth, differing from the number of exciter poles and the pole teeth thereof carrying at least one coil each and being connected with commutator laminates being in contact with each other in pairs vie contact bridges, wherein the number of laminates is a plurality of the pole teeth. To reduce the magnetic and electric ripple of the machine the number of the commutator laminates are a plurality of half of the pole pair number of the exciter poles, but not a plurality of the whole pole pair number, wherein the pole pair number has to be an even number.

### TECHNICAL FIELD

The invention concerns an electrical machine, preferably a direct current motor according to the category of claim 1.

### BACKGROUND

It is advantageous to choose high pole numbers for direct current motors with high torque and low engine speed. Additionally the use of a single-tooth winding allows a high performance or torque concentration. In order to achieve small torque ripple, the number of teeth should preferably be chosen in such a way that the least common multiple (KGV) of pole number and teeth number is as high as possible, so that many different magnetic breakaway positions develop between the teeth and poles per rotation. Thus a KGV of 88 results at for example an electrical direct current motor with eight exciter poles and a commutator rotor with eleven teeth. In order to keep the installation space and the manufacturing effort low for the electrical machine, the number of commutator laminates has to chosen as low as possible.

It is known from WO02/21665 A2 to use a plurality of the pole number for the number of the commutator laminates. It is also known to connect the commutator laminates in default distances with each other by contact bridges in order to reduce the number of brushes for example to two carbon brushes. Such familiar solutions have nevertheless the disadvantage of a relatively high number of commutator laminates with a corresponding installation space and manufacturing effort.

As long as the number of commutator laminates is a plurality of the pole pair number and the slot number, the same orders of the power and torque variations are induced that are caused by magnetic reluctance and electric commutation. This causes in particular an increased noise emission.

### SUMMARY

The present solution intends to reduce the number of commutator laminates by more than the familiar measure at a torque ripple of the electrical machine that is as small as possible.

Thus a maximum ripple reduction is established at electrical machines with the featured characteristics of claim 1 in an advantageous way by a useful combination of pole number, teeth number and laminate number. A further advantage is that by a compact constructing commutator the installation space and the manufacturing effort can be kept low for the machine. Moreover a reduced noise emission is achieved.

Advantageous embodiments and improvements of the characteristics that are stated in the main claim are established by the mentioned characteristics in the sub-claims.

Thus a better commutation of the coils is provided thereby that the commutator has two plus and two minus brushes, which are each offset to each other by half a laminate width more than the plurality of the whole laminate width. Thereby it is ensured that a current commutation under the two plus or minus brushes always takes place as a counter act, which is not the case at the familiar solutions with a brush offset by a whole plurality of the laminates width.

Thereby different solutions result depending on the number of laminates. Thus at an even number of laminates of the commutator the two plus brushes and the two minus brushes are each advantageously offset to each other by a double pole pitch of the exciter coil and at an uneven number of laminates the two plus brushes and the two minus brushes of the commutator are offset to each other by 180°. Furthermore an optimal current commutation is achieved at the electrical machine thereby that one of the minus brushes is offset to one of the plus brushes by a triple pole pitch (in direction of rotation of the machine). A further commutation optimization takes place thereby that the laminates of the commutator that have each been offset by four pole pitches to each other are connected by contact bridges to each other.

A very comfortable manufacturing of the coils and the contact bridges by automatic coiling machines is achieved thereby that the coils of the pole teeth and the contact bridges of the commutator are winded by a winding wire. Such electrical machines can preferably be used in varied applications in motor vehicles. An electrical machine with a commutator rotor consisting of eight pole teeth or slots as well as 22 laminates and an eight-pole exciter is here suggested among others as a preferred embodiment for a wiper direct drive.

### BRIEF DESCRIPTION OF THE DRAWINGS

The invention is further explained in the following by the figures. It is shown in:

FIG. 1 is a schematic illustration of the front view of the electrical machine according to the invention as a first embodiment;

FIG. 2 is a winding chart for the coils and contact bridges of the machine that have to created by automatic coiling machines;

FIG. 3a is a schematic illustration of an execution of the machine from FIG. 1 with the first three coils and contact bridges of the commutator rotor;

FIGS. 3b-3d show a further schematic illustration for producing the rotor winding according to the winding chart in FIG. 2 for the coils and the contact brushes 4 to 6, 7 to 9 and 10 to 11;

FIG. 4 is a schematic illustration of an eight-pole machine with 9 teeth and 18 laminates as a further embodiment;

FIG. 5 is a related winding chart;

FIG. 6 is a schematic illustration of the execution of the machine from FIG. 4 with the two first coils and contact bridges according to the winding chart in FIG. 5,

FIG. 7 is a schematic illustration of a twelve-pole electrical machine with 11 teeth and 33 laminates in a third embodiment and

FIG. 8 is the corresponding winding chart; and

FIG. 9 is the corresponding execution of the machine from FIG. 7 with the first three coils that have been created according to the winding chart in FIG. 8 and 6 contact bridges.

### DETAILED DESCRIPTION

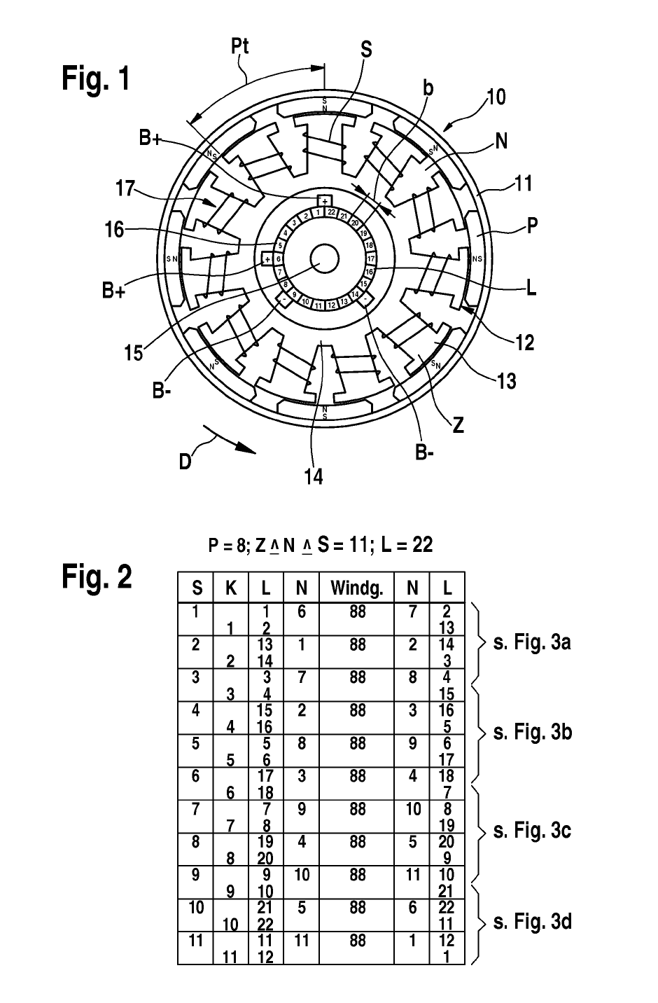

FIG. 1 schematically shows the front view of a permanently magnetically activated eight-pole direct current motor as electrical machine that is labeled with 10 for a first embodiment. Such machines are preferably used for actuators, fanners, windshield wipers and similar in motor vehicles and have to work reliably at high workloads for the entire operational life span of the motor vehicle. Further requirements are power and torque variations as low as possible and low noise emissions. The direct current motor 10 has an eight-pole stator 11, which interacts over a working air gap 12 with a commutator rotor 13 that is called rotor in the following. The rotor 13 consists of a laminated core 14, which is attached to a double-sided rotor shaft 15. At the scope of the laminated core 14 are 11 evenly spread pole teeth Z are arranged, in between which slots N are provided for the intake of overall 11 coils S of a rotor winding 17. The coils S are thereby created as single-tooth coils each on one pole tooth Z by automatic coiling machines. They are thereby wired up in a special way with a commutator 16 that is put on top of the rotor shaft 15 on the front side of the laminated core 14. The commutator has 22 laminates L that are evenly spread over the scope and that interact with two fixed plus carbon brushes B+ and two fixed minus carbon brushes B−. They are each offset by 90° to each other and are supplied with direct current for operating the electrical machine. The 11 pole teeth Z of the rotor 13 interact thereby with 8 exciter poles of the stator 11. In order to establish a torque ripple of the electrical machine that is as small as possible, the number of pole teeth differs from the number of exciter poles. Besides the number of laminates L is here twice as high as the number of pole teeth.

For an optimal magnetic reluctance and electric commutation of the machine it is furthermore required that the number of commutator laminates L is a plurality of half of the pole pair number of the exciter poles P, but not a plurality of the whole pole pair number. Furthermore the pole pair number has to be an even number. These conditions apply to the direct current motor 10 according to FIG. 1 with a pole pair number p=4 and a laminate number of 22. The commutation of the machine is furthermore thereby optimized, in that the two plus brushes B+ as well as the two minus brushes B− are offset to each other by half of a laminate width more than a plurality of the whole laminate width b. Thereby it is ensured that always when one of the plus brushes or minus brushes stands in the middle of a laminates L, the other plus brush or minus brush each bridge over two adjacent laminates L. For an optimal magnetic reluctance it is furthermore required at an even number of laminates of the commutator 16, that the two plus brushes B+ as well as the two minus brushes B− are each offset to each other by a double pole pitch Pt of the exciter poles P. This results at an eight-pole direct current motor 10 according to FIG. 1 in a brush offset of 90° each. It is furthermore required for an optimal commutation that one of the minus brushes B− is offset to one of the plus brushes B+ by a triple pole pitch Pt in the direction of the rotation of the arrow D of the machine.

FIG. 2 shows a winding chart, with which the 11 coils of the direct current motor 10 are created and wired up with the 22 laminates L of the commutator 16 as well as with the contact bridges K. The winding chart is thereby processed by an automatic coiling machine, in which the coils S of the pole teeth Z and the contact bridges K are each alternately wired by a winding wire.

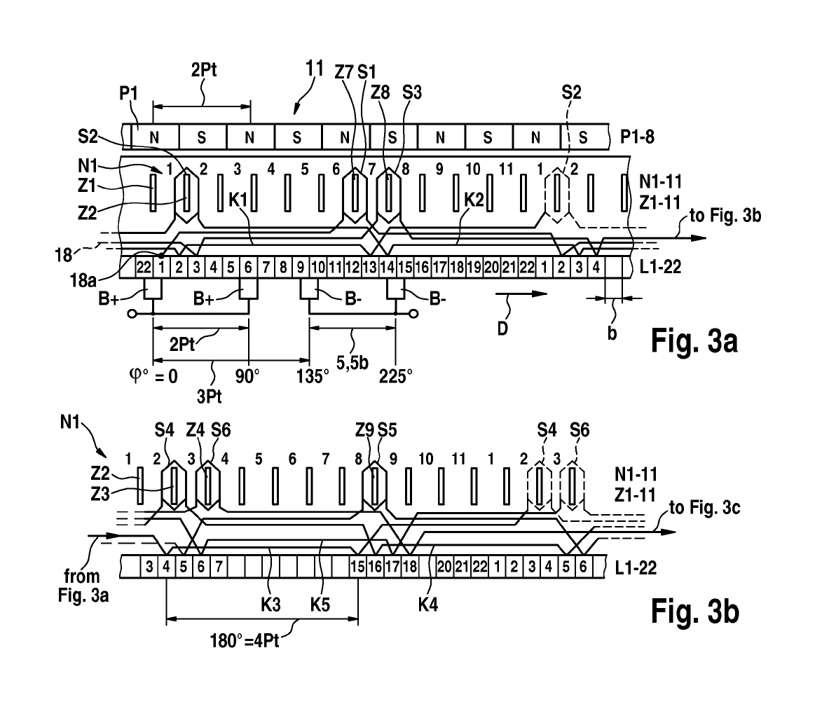

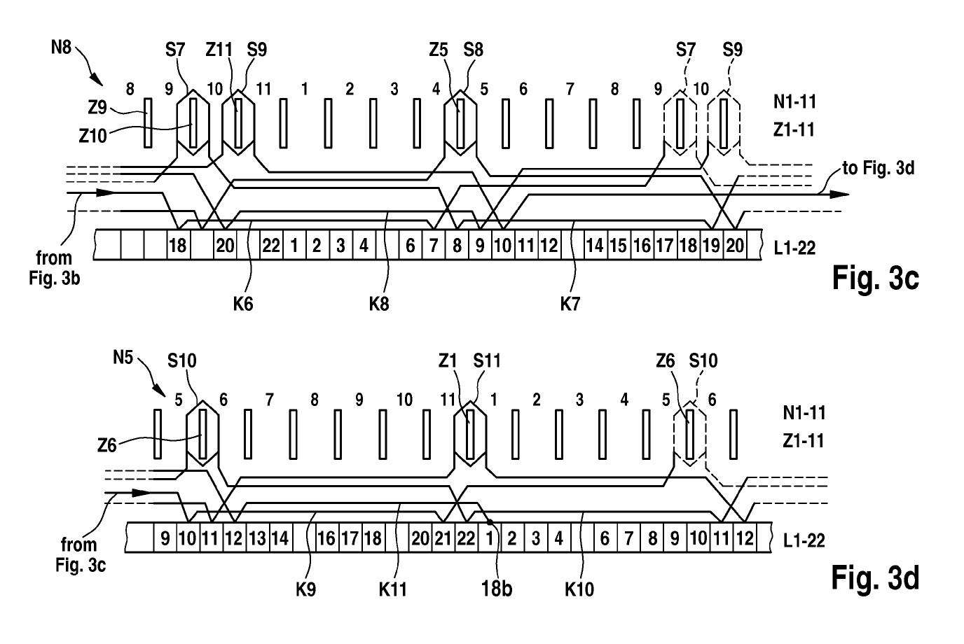

FIG. 3a to 3d show executions of the direct current motor 10 from FIG. 1 in a schematic illustration, with which the production of the coils S and the contact bridges K is illustrated in four sections according to the winding chart from FIG. 2 and described below. The eight-pole stator 11 with the poles P1 to 8, the eleven pole teeth Z1 to 11, the slots N1 to 11 and the commutator 16 with the laminates L1 to 22 can be noticed there.

FIG. 3a shows a first section for producing the rotor winding 17 with the coils S1 to S3 and the contact bridges K1 to K3. The winding start 18a is arbitrary and is here assigned to laminate L1. Furthermore the also arbitrary assignment of the commutator laminates L to the pole teeth Z is selected here in such a way that the first pole tooth Z1 lies exactly on the height of the laminates gap between laminate L1 and L22 of the commutator 16. This position shall now have the angle position of φ=0° according to FIG. 3a. Besides the first north pole P1 of the stator 11 stands in the middle over pole tooth Z1 in this position. While the first plus brush B+ bridges over laminates L22 and L1, the second plus brush B+ is offset by a double pole pitch 2 Pt, which means 90° in the direction of the rotation D, and stands in the middle of laminate L6. The first minus brush B− is arranged offset to the first plus brush B+ by a triple pole pitch 3 Pt, corresponding to an angle of 135° in the direction of the rotation D, and stands on laminate L9. The second minus brush B− is offset to it by 90° again and stands on laminates L14 and L15. The brush offset of the plus brushes as well as the minus brushes amount therefore each to five and a half times the laminate width (5.5 b).

The automatic coiling machine processes the winding chart according to FIG. 2 line by line, whereby coils S1 to S11 and the contact brushes K1 to 11 are winded one by one and are each contacted with their assigned laminates L of the commutator 16.

For a better overview the slots N and the laminates L are numbered consecutively in FIG. 3a to 3d. The coils that are illustrated twice in the executions are each shown dotted on the right side of FIGS. 3a to 3d.

Thereby it is proceeded as follows:

Beginning with coil S1 the winding wire 18 is initially attached to laminate L1 according to FIG. 3a, then the beginning of coil S1 is put through slot N6, thereupon 88 windings are winded around pole tooth Z7, in order to attach the coil end through slot N7 at laminate L2 thereafter. Subsequently the first contact bridge K1 is placed from laminate L2 to laminate L13 without interrupting the winding wire. Thence the start of the coil S2 is put through slot N1, the coil is winded with 88 windings around tooth Z2 and the end is lead through the slot N2 to laminate L14. Subsequently the contact bridge K2 is placed from here to laminate L3. Thence the start of coil S3 is put through slot N7, the coil winded around tooth Z8 and the end placed through slot N8 to laminate L4. From here the winding wire is transferred over to FIG. 3b.

According to FIG. 3b the contact bridge K3 follows now from laminate L4 to laminate L15. It can be thereby noticed that the contact bridges K each connect the laminates L of the commutator 16 that are offset to each other by 180°, which corresponds with a fourfold pole pitch 4 Pt. Subsequently the start of coil S4 is put from laminate L15 through slot N2, the coil winded around tooth Z3 with 88 windings and the end put through slot N3 onto laminate L16. Now the contact bridge K4 follows from laminate L16 to laminate L5. Thence the start of coil S5 is put through slot N8, the coil winded around tooth Z9 and the coil end put through slot N9 onto laminate L6. Now the contact bridge K5 follows from laminate L6 to laminate L17. Subsequently the start of coil S6 is put from laminate L17 through slot N3, the coil winded around tooth Z4 and the end put through slot N4 onto laminate L18. Thence the winding wire 18 is transferred to FIG. 3c.

According to FIG. 3c the contact bridge K6 follows now from laminate L18 to laminate L7. Subsequently the start of coil S7 is put from laminate L7 through slot N9, the coil winded around tooth Z10 and the end put through slot N10 onto laminate L8. Thereupon the contact bridge K7 follows from laminate L8 to laminate L19. Thence the start of coil S8 is put through slot N4, the coil winded around tooth Z5 and the end put through slot N5 onto laminate L20. Thereupon the contact bridge K8 follows from laminate L20 to laminate L9. Thence the start of coil S9 is put through slot N10, the coil winded around tooth Z11 with 88 windings and the coil end put through slot N11 onto laminate L10. The winding wire 18 is transferred to FIG. 3d from here.

According to FIG. 3d the contact bridge K9 follows now from laminate L10 to laminate L21. Subsequently the start of coil S10 is put from laminate L21 through slot N5, the coil winded around tooth Z6 with 88 windings and the end put through slot N6 onto laminate L22. Thereupon the contact bridge K10 follows from laminate L22 to laminate L11. Thence the start of coil S11 is put through slot N11, the coil winded around tooth Z1 and the end put through slot N1 onto laminate L12. At the end the contact bridge K11 is placed from laminate L12 to laminate L1. The winding wire 18 is here finally separated and creates the end 18b of the rotor winding 17.

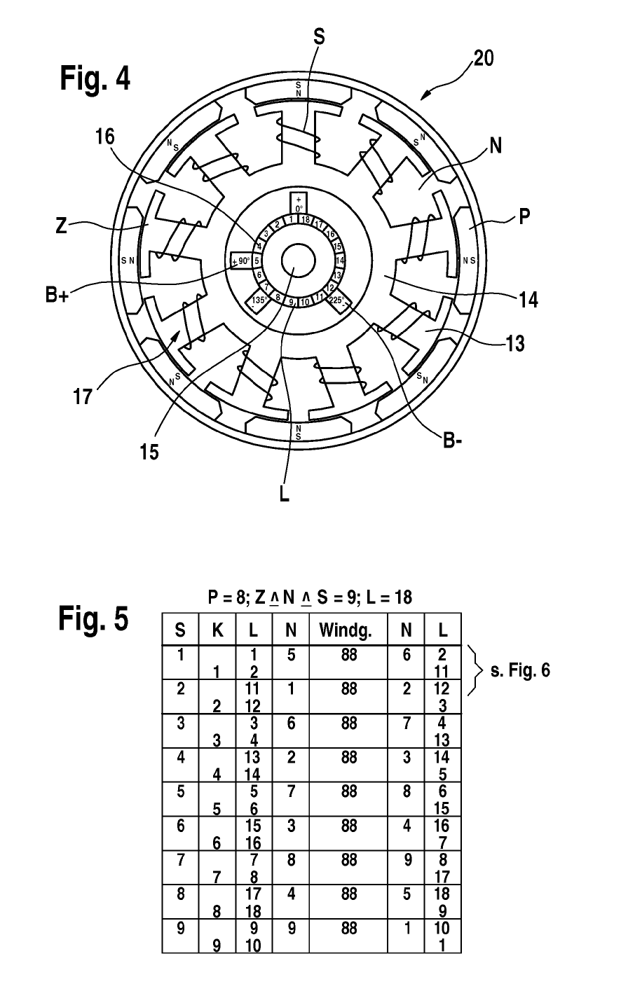

FIG. 4 shows a direct current motor 20 in a second embodiment, whose stator 11 again provides eight poles P. But the commutator rotor 13 is here supplied with only nine slots N or pole teeth Z, which each carry a coil S. The commutator 16 is here supplied with eighteen laminates L and is supplied with direct current over two plus brushes B+ and two minus brushes B−.

FIG. 5 shows a winding chart for the rotor winding 17 of the direct current motor 20 according to FIG. 4.

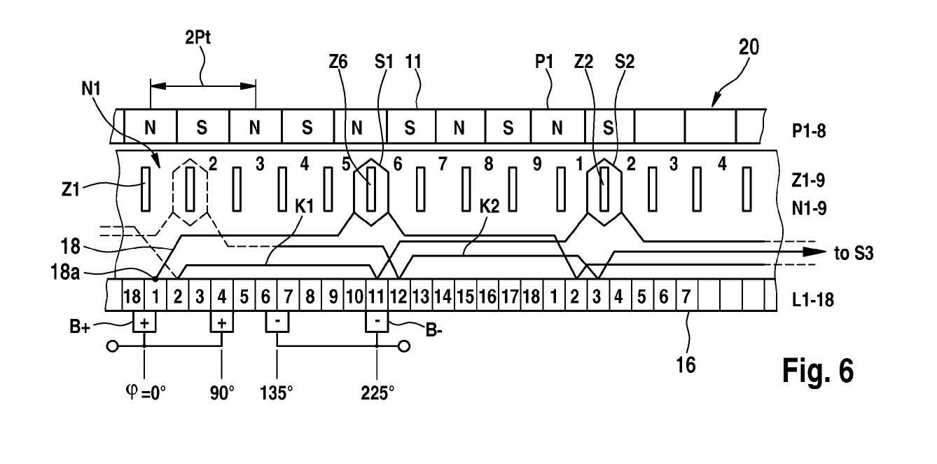

FIG. 6 again shows an execution of the direct current motor 20 from FIG. 4 in a schematic illustration, with which the production and wiring of the coils S and the contact bridges K for the first four winding sections of the winding chart from FIG. 5 are further explained in the following. The two plus brushes B+ and the two minus brushes B− are thereby offset to each other by 90° to each other like in the first embodiment, which corresponds with a double pole pitch 2 Pt at an eight-pole stator 11. The first minus brush B− is here also offset towards the first plus brush B+ by 135° or by three pole pitches.

It can be noticed from the winding chart according to FIG. 5 that the nine coils S and the contact bridges K have to be created by a continuing winding wire 18. It is thereby acted as follows:

Starting out with coil S1 the winding wire 18 is initially attached with the beginning 18a to laminate L1 according to FIG. 6, then the beginning of coil S1 is put through slot N5, thereupon 88 windings are winded around pole tooth Z6, in order to attach the coil end through slot N6 at laminate L2 thereafter. Subsequently the first contact bridge K1 is placed from laminate L2 to laminate L11 without interrupting the winding wire. Thence the start of the coil S2 is put through slot N1, the coil S2 is winded around tooth Z2 and the end is lead through the slot N2 to laminate L12. Subsequently the contact bridge K2 is placed from here to laminate L3. Thence the winding wire in the execution according to FIG. 6 is lead out on the right side to coil S3. Like in the first embodiment of FIG. 3a to FIG. 3d the winding chart according to FIG. 5 is also processed step by step in the second embodiment, until the winding wire finally gets back to laminate L1 with the last contact bridge K10 and is separated there.

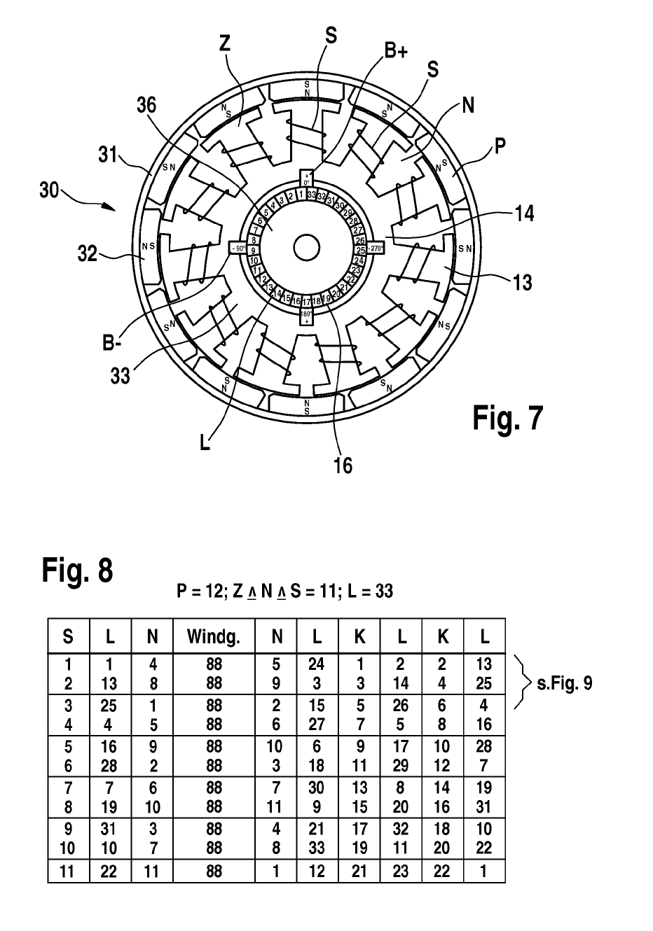

FIG. 7 shows a direct current motor 30 in a third embodiment, whose twelve-pole stator 31 has twelve permanent magnets 32 that are evenly spread at the scope. They create eight poles with alternating polarity, which interact with a rotor 33, which provides eleven slots N and pole teeth Z, on which each a coil S is wired. The eleven coils S are connected to a commutator 36, which provides thirty-three laminates L at its scope. The commutator laminates L interact with two plus brushes B+ and two minus brushes B− as electrical supply of the machine. The difference between this and the first two embodiments is that the commutator 36 has an uneven number of laminates L here. It is thereby possible to offset the two plus brushes B+ and the two minus brushes B− each by 180° to each other for an optimal commutation. The minus brushes B− are each offset by 90° to the plus brushes B+.

FIG. 8 shows a winding chart, with which the eleven coils S and 22 contact bridges K can be created with an automatic coiling machine. Differing form the previous embodiments after each coil two contact bridges K are created one after the other before the next coil follows. All coils S and contact bridges K can be wired here with a winding wire.

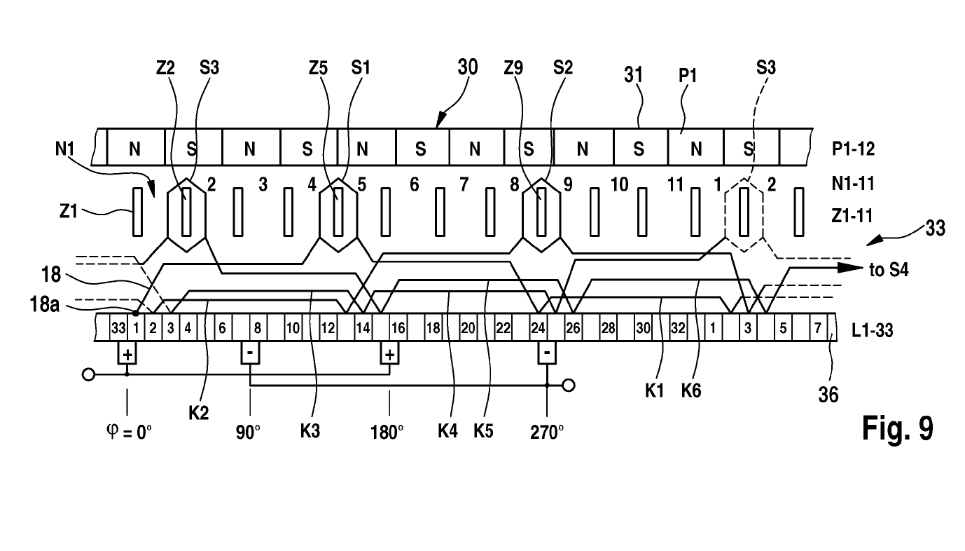

FIG. 9 shows the twelve-pole stator 31 with the rotor 33 and its commutator 36 in an execution of the direct current motor 30. With the winding chart from FIG. 8 the production and arrangement of the first three coils S and the first six contact bridges K is explained further with the aid of FIG. 9 in the following. Thereby the following step sequence arises:

Initially the winding wire 18 is attached at laminate L1 at the point 18a, then the beginning of coil S1 is put through slot N4, thereafter 88 windings are winded around pole tooth Z5, in order to attach the coil end thereupon through slot N5 at laminate L24. Subsequently the first contact bridge K1 is placed from laminate L24 to laminate L2 without interrupting the winding wire and at the same time the second contact bridge K2 is lead up to laminate L13. Thence the start of the coil S2 is put through slot N8, the coil is winded around tooth Z9 and the end is lead through the slot N9 to laminate L3. From here the contact bridge K3 is placed to laminate L14 and contact bridge K4 to laminate L25. Thence the beginning of coil S3 is put through slot N1, the coil winded around pole tooth Z2 and the end put through slot N2 to laminate L15. Thereafter contact bridge K5 follows to laminate L26 and contact bridge K6 to laminate L4. From laminate L4 the winding wire is lead out on the right side of the execution according to FIG. 9 to coil S4, whereby this winding step as well as all further winding steps that can be taken from the chart according to FIG. 8 are processed by an automatic coiling machine like it was explained in the first embodiment, until the winding wire finally gets back to laminate L1 with the last contact bridge K22 and is separated there.

At electrical machines, whose number of laminates is a plurality of the pole teeth number, the superior solution idea for reducing ripples of the magnetic reluctance and the electric commutation is that the number of the commutator laminates L is still a plurality of half of the pole pair number of the exciter poles in any case, but not a plurality of the whole pole pair number p, whereby the pole pair number has to be an even number. This solution idea is therefore not limited to the illustrated embodiments. Therefore further alternatives arise only for the rotor of the eight-pole electrical machine for example with thirteen slots/pole teeth and twenty-six commutator laminates or fifteen slots/pole teeth and thirty commutator laminates. Accordingly many alternatives also arise at four-pole, twelve-pole and sixteen-pole electrical machines.

A further superior characteristic of the embodiments is that the commutator provides two plus brushes B+ and two minus brushes B−, whereby the plus brushes as well as the minus brushes are offset to each other by half of the laminate width more than a plurality of the whole laminate width b. Thereby a low current ripple is achieved at the commutation of the machine by never commutating the current under both plus brushes and minus brushes from one laminate to an adjacent laminate at the same time. In doing so it is further achieved that the frequency of the magnetic ripple (pole pair number z teeth number) deviates from the frequency of the current ripple. This means low power and torque variations as well as low noise emissions.

1-10. (canceled)

11. An electrical machine, especially a direct current motor, comprising:
a stator having at least eight exciter poles; and
a rotor, comprising:
a commutator having plurality of commutator laminations, wherein the plurality of commutator laminations are in contact with each other in pairs via at least one contact bridge;
a plurality of slots; and
a plurality of pole teeth carrying at least one coil to be supplied with electric energy, wherein the at least one coil has a first and a second end connected with at least one of a plurality of commutator laminations;
wherein the plurality of commutator laminations and the plurality of pole teeth differ in number from the at least eight exciter poles, and wherein the plurality of commutator laminations is a multiple number of the plurality of pole teeth;
wherein the plurality of commutator laminations is further a multiple of half of a pole pair number of the at least eight exciter poles, and wherein the pole pair number is an even number.

12. The electrical machine of claim 11, wherein the commutator further comprises a pair of plus brushes and a pair of minus brushes, wherein the pair of plus brushes and the pair of minus brushes are offset to each other by a half lamination width more than a whole lamination width.

13. The electrical machine of claim 12, wherein the two pair of plus brushes and the pair of minus brushes are each offset to each other at an even number of laminations by a double pole pitch of the at least eight exciter poles.

14. The electrical machine of claim 12, wherein the pair of plus brushes and the pair of minus brushes are offset to each other at an uneven number of laminations by 180°.

15. The electrical machine of claim 12, wherein one of the pair of minus brushes is offset to the pair of plus brushes by a triple pole pitch.

16. The electrical machine of claim 11, wherein the laminations of the commutator offset to each other by a four pole pitch are connected to each other by at least one contact bridge.

17. The electrical machine of claim 11, wherein the at least one coil and the at least one contact bridge are winded by a winding wire with the aid of an automatic coiling machine.

18. The electrical machine of claim 11, whereinupon providing a stator having eight poles, the commutator rotor comprises eleven pole teeth or slots and twenty-two laminations.

19. The electrical machine of claim 11, whereinupon providing a stator having eight poles, the commutator rotor comprises nine pole teeth or slots and eighteen laminations.

20. The electrical machine of claim 11, whereinupon providing a stator having twelve-poles, the commutator rotor comprises eleven pole teeth or slots and thirty-three laminations.
